(19) United States
(12) Patent Application Publication
(10) Pub. No.: US 2009/0170492 A1
(43) Pub. Date: Jul. 2, 2009

(54) User-programmed automated communications

(75) Inventor: Michael M. Lee, San Jose, CA (US)

Correspondence Address: APPLE INC./BSTZ;BLAKELY SOKOLOFF TAYLOR & ZAFMAN LLP, 1279 OAKMEAD PARKWAY, SUNNYVALE, CA, 94085-4040, US

(73) Assignee: Apple Inc., Cupertino, CA (US)

(21) Appl. No.: 12/005,676

(22) Filed: Dec. 28, 2007

(51) Int. Cl. H04M 3/00

(52) U.S. Cl. 455/418

(57) ABSTRACT

A communications device may be programmed to initiate a communications operation when a particular condition is met. The user may set any suitable condition, including for example a date and time, location, event, received or sent communications operation, or any other suitable criteria. The user may select any suitable contact method for the communications operation, including for example telephone, voicemail, email, text message, chatting, fax, or any other suitable method.

### BACKGROUND OF THE INVENTION

As individuals travel more and assume more responsibilities, they often forget to communicate with relatives and friends, or forget to meet other appointments or obligations. For example, an individual may choose not to follow up on a previously-planned communication once he or she remembers it because the individual may be located in one time zone and the recipient of the communication may be located in another time zone. The communication also may not occur because it may be forgotten.

Using some existing communications devices, users may be required to direct the communications device to perform a communications operation. For example, the user may provide an input such as a verbal command, an entry keyed in on a keypad, or an option chosen from a menu. In each case, the user's input immediately precedes the initiation of the outgoing communications operation.

### SUMMARY OF THE INVENTION

Systems and methods are provided for programming a communications device to generate a communications operation upon the occurrence of a determined criterion, even if the device is turned off.

The present invention permits a user to schedule a communications operation to occur automatically when a determined condition is met without the communication occurring immediately thereafter, or without requiring the user to input information immediately prior to the communication. This communications operation can occur regardless of where the user is located or what the user is doing at the time. The communications device may be any device suitable for transmitting a communication (e.g., voice or data) as part of a communications operation. The communications operation may comprise audio communications (e.g., telephone or video conversations), data communications (e.g., e-mail, instant messaging, text messaging), or any combination thereof. The communication may be sent via any suitable means for transmitting voice or data (e.g., via a wired telephone line or via cable line, or via a wireless network).

The user can set any suitable condition for scheduling a communications operation. In one embodiment, the communications device may initiate a communications operation at a specific date and time. For example, if the user knows that he will be traveling on a particular day, he may program the communications device to call a family member on that day to confirm his travel plans. In another embodiment, the user can employ an electronic calendar that is synched to the communications device to schedule a communications operation when an event in the calendar occurs. In some embodiments, the communications device may initiate a communications operation based on the location of the communications device. For example, the user may program the communications device to initiate a communications operation when the user (and the communications device) are at a particular location (e.g., the user is at a hotel).

In some embodiments, the communications device may perform a communications operation in response to receiving or sending a communication to a particular contact. For example, in response to receiving an email from a first contact, the communications device may automatically call a second contact. In some embodiments, the communications device may initiate a communications operation in response to any other user defined criteria.

When the communications device performs a scheduled communications operation, the communications device may provide an indication (e.g., ring or vibrate) of the communications operation to the user. The communications device may perform any suitable operation in response to determining that a scheduled communications operation was successful (e.g., the other device accepted the communications request). For example, the communications device may prompt the user to communicate (e.g., speak on the phone). As another example, the communications device may provide a default communication (e.g., a recorded comment). The communications device may terminate a scheduled communications operation at any suitable time. For example, if the communications operation is not successful (e.g., the recipient does not respond within a particular amount of time or number of rings), the communications device may terminate the scheduled communications operation. As another example, if the user of the communications device initiating the communications operation is not available (e.g., does not respond when the communications operation is initiated), the communications device may terminate the scheduled communications operation.

### BRIEF DESCRIPTION OF THE DRAWINGS

The above and other advantages of the present invention will be apparent upon consideration of the following detailed description, taken in conjunction with accompanying drawings, in which like reference characters refer to like parts throughout, and in which:

FIG. 1 is a schematic view of a communications system in accordance with one embodiment of the invention;

FIG. 2 is a schematic view of a communications device in accordance with one embodiment of the invention;

FIG. 3 is a simplified illustration of a scheduled communications operation in accordance with one embodiment of the present invention;

FIG. 4 is a schematic view of an illustrative display screen for viewing selectable communications device options in accordance with one embodiment of the invention;

FIG. 5 is a schematic view of an illustrative display screen for scheduling a communications operation in accordance with one embodiment of the invention;

FIG. 6 is a schematic view of a display screen for scheduling a communications operation based on a date or time in accordance with one embodiment of the invention;

FIG. 7 is a schematic view of a display screen for scheduling a communications operation based on an event in accordance with one embodiment of the invention;

FIG. 8 is a schematic view of a display screen for scheduling a communications operation based on a received communication in accordance with one embodiment of the invention;

FIG. 9 is a schematic view of a display screen for scheduling a communications operation based on a sent communication in accordance with one embodiment of the invention;

FIG. 10 is a schematic view of a display screen for scheduling a communications operation based on a location in accordance with one embodiment of the invention;

FIG. 11 is a schematic view of a display screen for scheduling a communications operation based on a suitable criteria in accordance with one embodiment of the invention;

FIG. 12 is a schematic view of a display screen for viewing scheduled communications operations in accordance with one embodiment of the invention;

FIG. 13 is a schematic view of an illustrative data structure for storing scheduled communications operations in accordance with one embodiment of the invention;

FIG. 14 is a schematic display screen of a scheduled communications operation as it is initiated in accordance with one embodiment of the invention;

FIG. 15 is a flow chart of an illustrative process for performing a scheduled communications operation in accordance with one embodiment of the invention;

FIG. 16 is a flowchart of an illustrative process for scheduling a communications operation in accordance with one embodiment of the invention; and

FIG. 17 is a flowchart of an illustrative process for scheduling a communications operation in accordance with one embodiment of the invention.

### DETAILED DESCRIPTION OF THE INVENTION

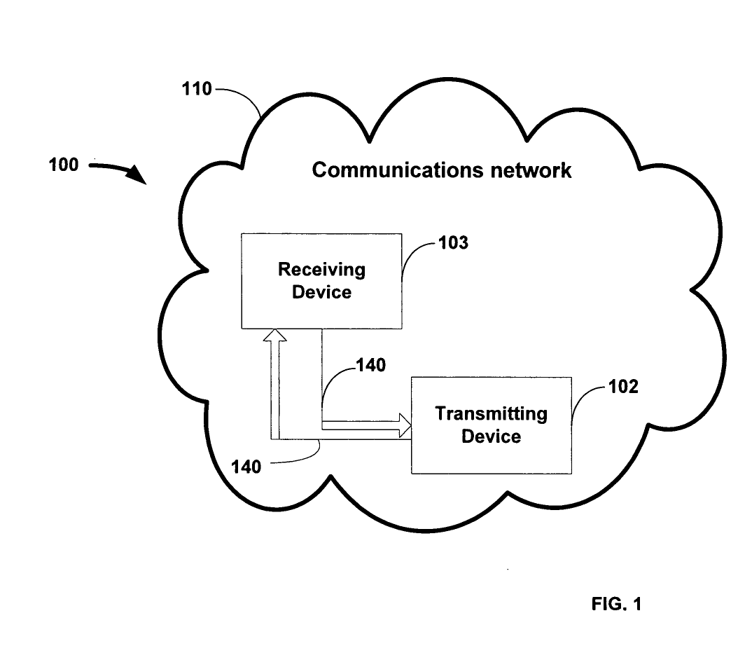

FIG. 1 is a schematic view of a communications system in accordance with one embodiment of the invention. Communications system 100 may include a communications device that initiates an outgoing, scheduled communications operation (transmitting device 102) and communications network 110, which transmitting device 102 may use to initiate and conduct communications operations with other communications devices within communications network 110. For example, communications system 100 may include a communications device that receives the scheduled communications operation from the transmitting device (receiving device 103). Although communications system 100 may include several transmitting devices 102 and receiving devices 103, only one of each is shown in FIG. 1 to simplify the drawing.

Any suitable circuitry, device, system or combination of these (e.g., a wireless communications infrastructure including communications towers and telecommunications servers) operative to create a communications network may be used to create communications network 110. Communications network 110 may be capable of providing communications using any suitable communications protocol. In some embodiments, communications network 110 may support, for example, traditional telephone lines, cable television, Wi-Fi (e.g., a 802.11 protocol), Bluetooth (registered trademark), high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VOIP or LAN. Transmitting device 102 and receiving device 103, when located within communications network 110, may communicate over a bidirectional communication path such as path 140. Both transmitting device 102 and receiving device 103 may be capable of initiating a communications operation and receiving an initiated communications operation.

Transmitting device 102 and receiving device 103 may include any suitable device for sending and receiving communications operations. For example, transmitting device 102 and receiving device 103 may include a media player such as an ipod available from Apple Inc., of Cupertino, Calif., a cellular telephone or a landline telephone, a personal e-mail or messaging device (e.g., a Blackberry® or a Sidekick®), an iphone available from Apple Inc., pocket-sized personal computers such as an iPAQ Pocket PC available by Hewlett Packard Inc., of Palo Alto, Calif., personal digital assistants (PDAs), a desktop computer, a laptop computer, or any other device capable of communicating wirelessly (with or without the aid of a wireless enabling accessory system) or via wired pathways (e.g., using traditional telephone wires). The communications operations may include any suitable form of communications, including for example, voice communications (e.g., telephone calls), data communications (e.g., e-mails, text messages, media messages), or combinations of these (e.g., video conferences).

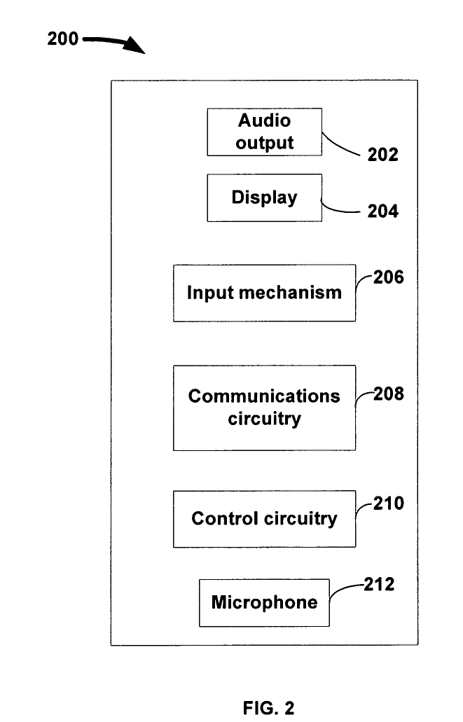

FIG. 2 is a schematic view of a communications device in accordance with one embodiment of the invention. Both transmitting device 102 (FIG. 1) and receiving device 103 (FIG. 1) may include some or all of the features of communications device 200. Communications device 200 may include audio output 202, display 204, input mechanism 206, communications circuitry 208, control circuitry 210, microphone 212, and any other suitable components. All of the applications employed by audio output 202, display 204, input mechanism 206, communications circuitry 208 and microphone 212 may be interconnected and managed by control circuitry 210.

Audio output 202 may include any suitable audio component for providing audio to the user of communications device 200. For example, audio output 202 may include one or more speakers (e.g., mono or stereo speakers) built into communications device 200. In some embodiments, audio output 202 may include an audio component that is remotely coupled to communications device 200. For example, audio output 202 may include a headset, headphones or earbuds that may be coupled to communications device 200 with a wire (e.g., coupled to communications device 200 with a jack) or wirelessly (e.g., Bluetooth® headphones or a Bluetooth® headset).

Display 204 may include any suitable screen or projection system for providing a display visible to the user. For example, display 204 may include a screen (e.g., an LCD screen) that is incorporated in communications device 200. As another example, display 204 may include a movable display or a projecting system for providing a display of content on a surface remote from communications device 200 (e.g., a video projector). Display 204 may be operative to display content (e.g., information regarding initiated communications operations or information regarding scheduling parameters) under the direction of control circuitry 210.

Input mechanism 206 may be any suitable mechanism for providing user inputs or instructions to communications device 200. Input mechanism 206 may take a variety of forms, such as a button, keypad, dial, a click wheel, or a touch screen. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety.

Communications circuitry 208 may be any suitable communications circuitry operative to connect to a communications network (e.g., communications network 110, FIG. 1) and to transmit communications (e.g., voice or data) from communications device 200 to other devices within the communications network. Communications circuitry 208 may be operative to interface with the communications network using any suitable communications protocol such as, for example, Wi-Fi (e.g., a 802.11 protocol), Bluetooth (registered trademark), high frequency systems (e.g., 900 MHz, 2.4 GHz, and 5.6 GHz communication systems), infrared, GSM, GSM plus EDGE, CDMA, quadband, and other cellular protocols, VOIP, or any other suitable protocol.

In some embodiments, communications circuitry 208 may be operative to create a communications network using any suitable communications protocol. For example, communications circuitry 208 may create a short-range communications network using a short-range communications protocol to connect to other devices. For example, communications circuitry 208 may be operative to create a local communications network using the Bluetooth® protocol to couple communications device 208 with a Bluetooth® headset.

Control circuitry 210 may be operative to control the operations and performance of communications device 200. Control circuitry 210 may include, for example, a processor, a bus (e.g., for sending instructions to the other components of communications device 200), memory, storage, or any other suitable component for controlling the operations of communications device 200. In some embodiments, a processor may drive the display and process inputs received from the user interface. The memory and storage may include, for example, cache, Flash, ROM, and/or RAM. In some embodiments, memory may be specifically dedicated to storing firmware (e.g., for device applications such as an operating system, user interface functions, and processor functions). In some embodiments, memory may be operative to store information related to other devices with which the communications device performs communications operations (e.g., saving recipient contact information or storing information related to a scheduled outgoing communications operation programmed by the user).

Control circuitry 210 may be operative to perform the operations of one or more applications implemented on communications device 200. Any suitable number or type of applications may be implemented. Although the following discussion will enumerate different applications, it will be understood that some or all of the applications may be combined into one or more applications. For example, communications device 200 may include a calendar and clock application (e.g., as a single application or as two distinct applications). The clock application may be configured to keep track of time within communications device 200, and to display the current time for a current time zone. The application may use any suitable approach for determining the current time and how to measure time lapses. For example, the clock application may measure time based on processor cycles, using an internal clock mechanism (e.g., a quartz crystal), or by receiving time stamps from an outside source. The calendar application may be operative to keep track of the current and past or future dates (for example, based on the current time provided by the clock application). In some embodiments, the calendar application may be operative to be synched with a calendar application of another electronic device (e.g., with iCal or Outlook running on a computer).

In some embodiments, communications device 200 may include one or several applications operative to perform communications operations. For example, communications device 200 may include a messaging application, a mail application, a telephone application, a voicemail application, an instant messaging application (e.g., for chatting), a fax application, or any other suitable application for performing any suitable communications operation.

In some embodiments, communications device 200 may include one or more applications operative to determine the current position of communications device 200. For example, communications device 200 may include an application that determines the current position of the device based on the outputs of a GPS receiver. As another example, the application may determine the current position using RF triangulation from RF detectors or signals received by the device (e.g., computed based upon the detected signal strength of one or more nearby wireless access points, the angle of the signal's approach to the device, the amount of time for the signal to reach the device, or any combination of the aforementioned measurements). As still another example, the application may determine the position of the device using RF fingerprinting (e.g., compare the device's view of the network infrastructure—i.e., the strength of signals transmitted by infrastructure access points—with a database that contains an RF physical model of the coverage area). As yet another example, the application may determine the position of the device from a cellular network cell in which the device is currently located, or from the nearest base station or transmitter within the cellular network cell. As still yet another example, the application may determine the position of communications device 200 from geographic coordinates downloaded associated with a wireless network (e.g., Wi-Fi) over the wireless network. These and other methods for determining the position of the communications device are described in more detail in commonly assigned U.S. patent application Ser. No. ______, filed ______, entitled LOCATION-BASED MODES FOR PORTABLE MEDIA DEVICES (Attorney Docket No. 104677-0054-101 (P4788US1)).

In some embodiments, communications device 200 may include microphone 212. For example, communications device 200 may include microphone 212 to allow the user to transmit audio (e.g., voice audio) during a communications operation or as a means of programming the scheduled outgoing communication. Microphone 212 may be incorporated in communications device 200, or may be remotely coupled to communications device 200. For example, microphone 212 may be incorporated in wired headphones, or microphone 212 may be incorporated in a wireless headset. An illustrative wired headset with an in-line microphone may be found in U.S. Provisional Patent Application No. 60/879,155, filed Jan. 6, 2007 (Attorney Docket No. P5021USP1), which is incorporated herein in its entirety. An illustrative wireless headset that includes a microphone may be found in U.S. Patent Application No. 60/879,177, filed Jan. 6, 2007 (Attorney Docket No. P4672USP1), which is incorporated herein in its entirety.

Communications device 200 may include any other component suitable for performing a communications operation. For example, communications device 200 may include a power supply, ports or interfaces for coupling to a host device, a secondary input mechanism (e.g., an ON/OFF switch), or any other suitable component.

A user may direct communications device 200 to perform a communications operation using any suitable approach. As one example, a user may receive a communications request from another device (e.g., an incoming telephone call, an email or text message, an instant message), and may initiate a communications operation by accepting the communications request. As another example, the user may initiate a communications operation by identifying another device and transmitting a request to initiate a communications operation (e.g., dialing a telephone number, sending an email, typing a text message, or selecting a chat screen name and sending a chat request).

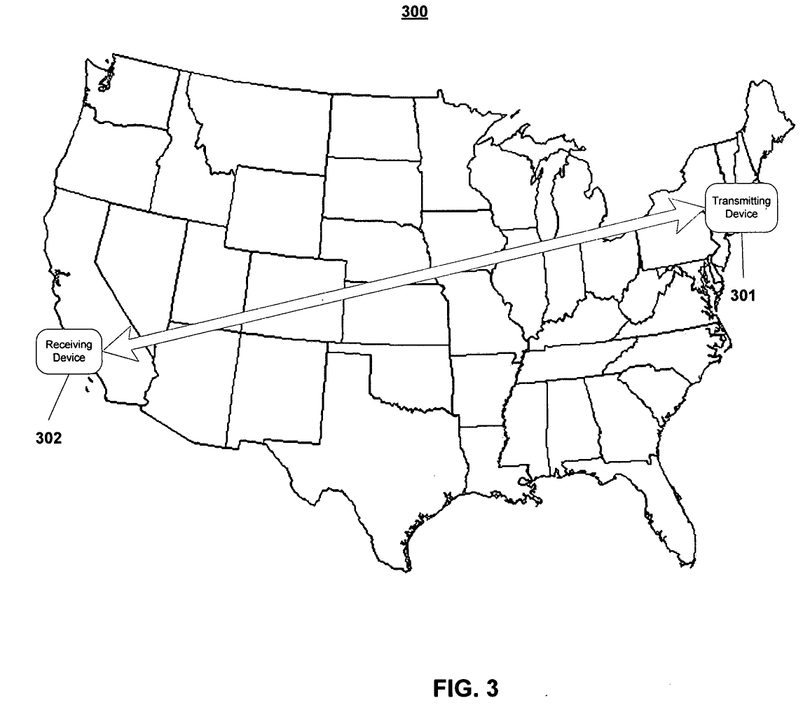

A problem may arise, however, if the user is prevented from initiating an intended communications operation. For example, if a user travels to one edge of the country while the recipient of an intended communications operation remains on the opposite edge of the country, the user may risk forgetting to initiate the communications operation because of changes in time zone, changes in travel plans, or any other situation that may arise and may cause the user to forget or be unable to initiate the communications operation at the desired time. To avoid such situations, the user may schedule a communications operation in advance using the user's communications device. FIG. 3 is a simplified illustration of a scheduled communications operation in accordance with one embodiment of the present invention. Map 300 is a representation of the United States of America. Transmitting device 301, which may include some or all of the features of communications device 200 (FIG. 2), may be located within the Eastern Time Zone. Receiving device 302, which may include some or all of the features of communications device 200, may be located within the Pacific Time Zone. There may therefore be a three-hour time difference between transmitting device 301 and receiving device 302. If a criterion selected by the user for initiating a communications operation is met, transmitting device 301 may initiate a communications operation with receiving device 302 without requiring any user input at the time the communications operation is initiated. The user may select any suitable criteria for initiating a scheduled communications operation. Such criteria may include, for example, a particular date and/or time, an event, a location, a condition based on a prior communications operation, a condition based on a non-communications operation, any combination therein, or any other suitable criteria for setting a condition.

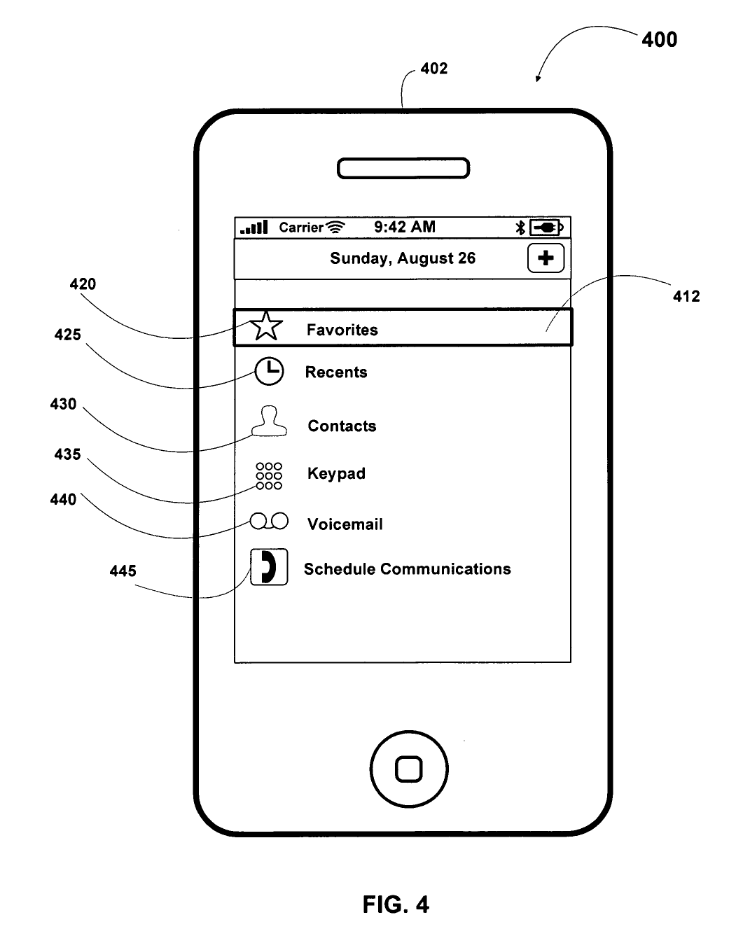

The user may schedule a communications operation by selecting one or more options displayed on the screen of a communications device. FIGS. 4-12 and 14 are schematic views of illustrative display screens which may be displayed as a user sets up and views scheduled communications operations. The communications device of each of FIGS. 4-12 and 14 may be the same or different, and may include some or all of the features of communications device 200. The user may provide inputs to the communications device using any suitable input mechanism, including for example an interface that includes a touch screen, a “home” button, a click-wheel, combinations thereof, or any other suitable input mechanism.

FIG. 4 is a schematic view of an illustrative display screen for viewing selectable communications device options in accordance with one embodiment of the invention. Display screen 400 may be displayed in communications device 402 at any suitable time. For example, display screen 400 may be displayed when communications device 402 is activated (e.g., turned on or awakened from a sleep mode), or in response to receiving a user instruction to access communications options (e.g., a telephone application).

Display screen 400 may include several selectable options for operating different functions of communications device 402. Displayed icons may include, for example, Favorites option 420, Recents option 425, Contacts option 430, Keypad option 435, Voicemail option 440, Schedule Communications option 445, or any other suitable option. The user may select Favorites option 420 to recall a list of favorite or preferred contacts with which to perform communications operations. The contacts displayed in response to selecting Favorites option 420 may be quickly displayed and accessed (e.g., akin to a speed-dial feature). Recents option 425 may be selected to display the other parties of recent communications operations (e.g., recent outgoing and incoming communications operations). Contacts option 430 may be selected to display a list of contacts stored in or accessible by communications device 402. Keypad option 435 may be selected to display a keypad (e.g., for dialing telephone numbers) or a keyboard (e.g., for entering an e-mail address). Voicemail option 440 may be selected to connect to a user's voicemail service to check the user's voicemail messages. In some embodiments, communications device 402 may include an Inbox option, which may be selected to display e-mail or text messages received by the user.

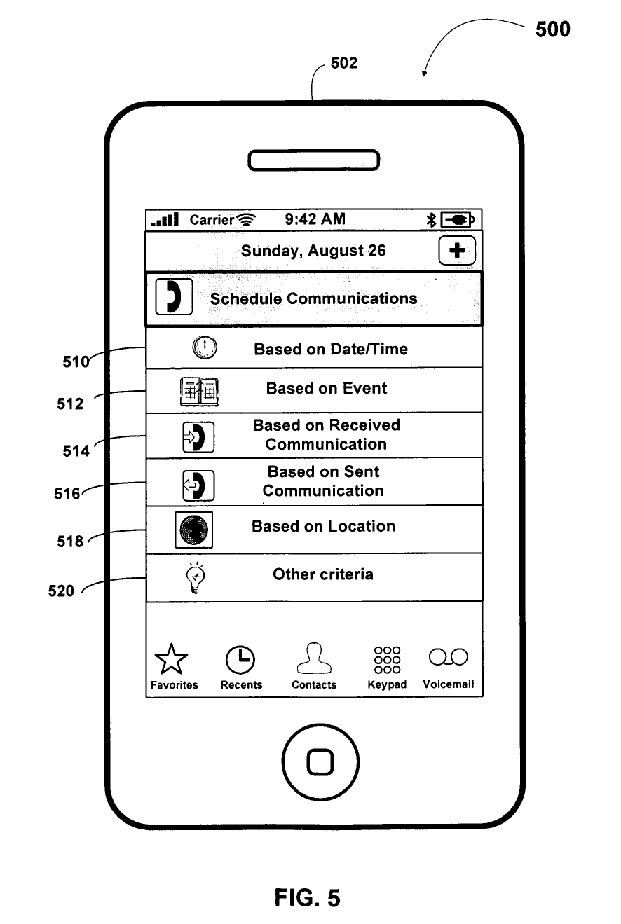

The user may schedule communications operations to be performed at a future time by selecting Schedule Communications option 445. In some embodiments, the user may provide any other suitable input to indicate an instruction to schedule a communications operation (e.g., by moving highlight region 412). In response to receiving a selection of Schedule Communications option 445, communications device 402 may display a series of options for scheduling a future communications operation to be automatically performed by communications device 402. FIG. 5 is a schematic view of an illustrative display screen for scheduling a communications operation in accordance with one embodiment of the invention.

Display screen 500 may be displayed by communications device 502 in response to receiving a user selection of a Schedule Communications option (e.g., Schedule Communications option 445, FIG. 4). Display screen 500 may include several selectable options for selecting a type of condition that must be met for a scheduled communications operation to occur. For example, display screen 500 may include Date/time option 510, Event option 512, Received communication option 514, Sent communication option 516, Location option 518, and Other criteria option 520. In response to selecting Date/time option 510, the user may schedule a communications operations at a set date and time. In response to selecting Event option 512, the user may schedule a communications operation in response to the occurrence of an event. In response to selecting Received communication option 514, the user may schedule a communications operation in response to receiving a communications operation. In response to selecting Sent communication option 516, the user may schedule a communications operation in response to sending a communications operation. In response to selecting Location option 518, the user may schedule a communications operation based on the location of the communications device 502. In response to selecting Other criteria option 520, the user may define any other suitable criteria defining a condition for a scheduled communications operation to occur.

In some embodiments, the user may schedule a communications operation based on several conditions. For example, the user may select several options displayed in display screen 500, such that a scheduled communications operation is performed when one, some or all of the several conditions are met. For example, the user may schedule a telephone call to a friend that is to occur if the current time is after 6 PM and if the user is not in his home town.

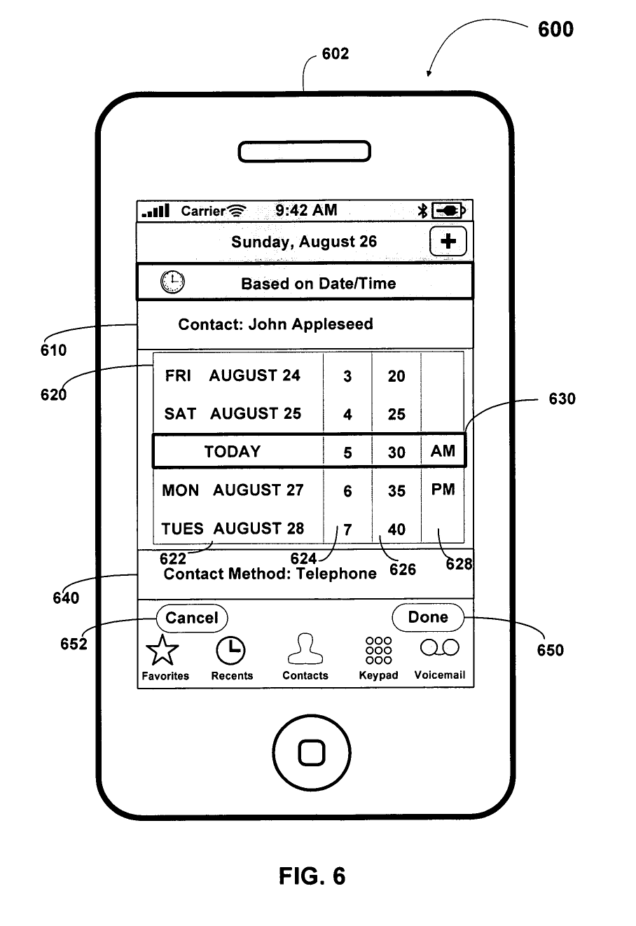

The communications device may display any suitable screen or menu for scheduling a communications operation based on a date and/or time in response to receiving a user selection of Date/time option 510 (FIG. 5). FIG. 6 is a schematic view of a display screen for scheduling a communications operation based on a date or time in accordance with one embodiment of the invention. Display screen 600 may be displayed by communications device 602 in response to receiving a user selection of Date/time option 510. Display screen 600 may include several options, including contact option 610, calendar option 620, and contact method option 640.

To select a contact with whom to schedule a communications operation, the user may select contact option 610. In response to receiving a user selection of contact option 610, the communications device may display available contacts using any suitable approach. For example, the communications device may display a listing of available contacts (e.g., the contacts displayed in response to receiving a user selection of a contacts option in a mail application). As another example, display screen 600 may include arrows for scrolling through contacts (e.g., all contacts, recent contacts, or favorite contacts). As still another example, the communications device may display a keypad or keyboard for entering contact information.

The user may select the date and time at which a communications operation takes place using any suitable approach. In some embodiments, calendar option 620 may include several options for selecting a date and time. For example, calendar option 620 may include one or more wheels that the user may scroll to select a date and a time. In the example of FIG. 6, calendar option 620 may include date wheel 622, hour wheel 624, minute wheel 626 and AM/PM wheel 628, which the user may independently scroll to select a particular date and time at which a communications operation is to be scheduled. The currently selected date and time in option 620 (e.g., from each of wheels 622, 624, 626 and 628) may be identified using highlight region 630. As another example, calendar option 620 may include a calendar (e.g., for selecting a date) and a second field for entering a time. In some embodiments, display screen 600 (e.g., as part of calendar option 620) may include selectable options for repeating a scheduled communications operation at the same time on different days (e.g., every day, only weekdays, only weekends) or at different times (e.g., three times a day, to remind the contact identified by option 610 to take a pill). In some embodiments, display screen 600 may include an option for setting a time zone (e.g., set a time zone, or use the “current” time zone, which may be determined based on the location of communications device 602).

The user may select the communication method to use for the scheduled communication using any suitable approach. For example, the user may select contact method option 640 for identifying one or more contact methods. In response to receiving a user selection of contact method option 640, communications device 602 may provide the user with the option of identifying one or more communications methods for performing the communications operation. For example, the communications device may display selectable listings of types of communications operations. As another example, the user may use arrows displayed in display screen 600 to scroll through available types of communications operations.

Communications device 602 may allow the user to schedule any suitable type of communications operation. Such types of communications operations may include, for example, a telephone call, a text message (e.g., SMS or MMS), an email, a post to a blog, a voicemail, a fax, a chat (e.g., by opening a chat window), or any other suitable communications operation. In some embodiments, communications device 602 may limit the available communications operations based on the selected contact (e.g., do not allow the user to select email if the communications device does not have the selected contact's email address), or may prompt the user to enter additional contact information to access a particular communications operation. In some embodiments, the user may select several types of communications operations that are to be used to reach the selected contact (e.g., first use a telephone call, and if the contact does not pick up, send a text message, and if the contact does not respond, leave a voicemail).

If the user selects a communications operation that does not involve a real-time input from the user (e.g., not a telephone conversation), communications device 602 may prompt the user to provide an appropriate message for the scheduled communications operation. For example, if the selected contact method is email, communications device 602 may display a screen for composing an email. Similarly, if the selected contact method is fax or text message, communications device 602 may display a screen for composing a fax or a text message. If the selected contact method is voicemail, communications device 602 may prompt the user to record a voicemail to be transmitted when the scheduled communications operation occurs. In some embodiments, if the selected contact method is telephone, communications device 602 may prompt the user to record a message to be played if the user is not available for a telephone conversation when the scheduled communications operation occurs.

To ease the burden on the user of providing different messages for each scheduled communications operation, communication device 602 may provide the user with several default or generic messages to send. For example, communications device 602 may display a screen with listings of default messages (e.g., listings by title or by first words of the messages). Communications device 602 may instead or in addition save all prior messages prepared by the user (e.g., from the scheduled communications context and from the mail or text messages applications) for selection by the user.

In some embodiments, communications device 602 may provide the user with an option for having a scheduled communications operation expire if the condition is not met by a particular time, or if something else occurs before the condition is met. For example, communications device 602 may cancel a scheduled communications operation if the user communicates with the contact before the condition is met (e.g., before the set date and time). In some embodiments, the scheduled communications operation may be canceled only if the user communicates with the contact in a time window sufficiently near the set condition (e.g., cancel only if the user communicates with the contact within 4 hours of the condition date and time). In some embodiments, a scheduled communications operation may be canceled only if the communication between the user and the contact is performed using one or more particular contact methods (e.g., specified by the user, or the same contact method as in the scheduled communications operation). As another example, a scheduled communications operation may be canceled if the device is located at a particular place before the condition is met (e.g., if the user goes home before going abroad, the scheduled communication to home is canceled). Any other approach may be used to determine whether to cancel a scheduled communications operation.

Once the user has finished scheduling a communications operation, the user may select Done option 650 or provide any other suitable input to schedule the requested communications operation. The user may cancel the scheduling of a communications operation by selecting Cancel option 652, or by providing any other suitable input.

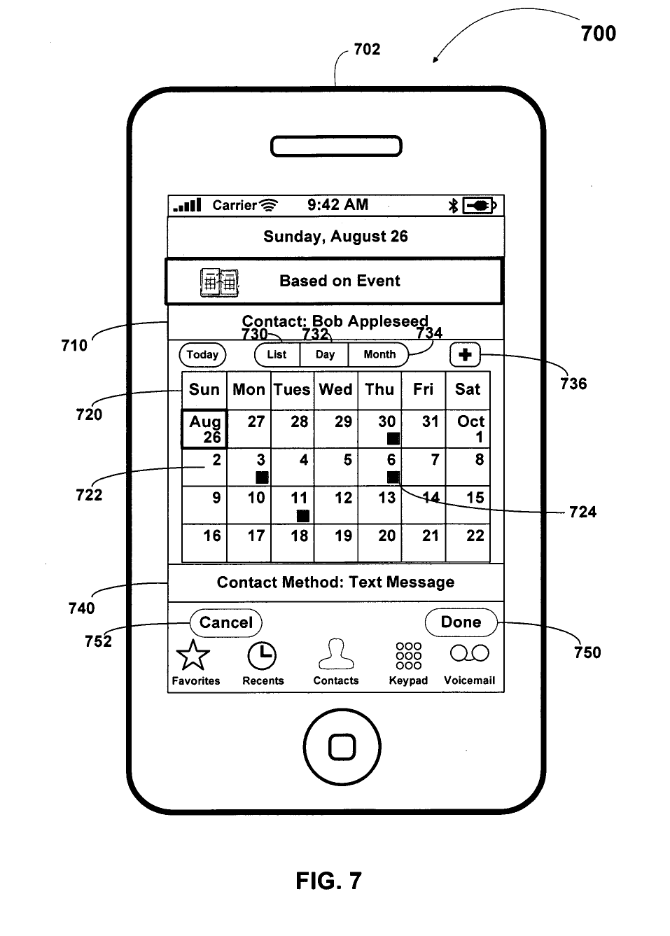

The communications device may display any suitable screen or menu for scheduling a communications operation based on an event. FIG. 7 is a schematic view of a display screen for scheduling a communications operation based on an event in accordance with one embodiment of the invention. Display screen 700 may be displayed by communications device 702 in response to receiving a user selection of Event option 512 (FIG. 5). Display screen 700 may include several options, including contact option 710, events option 720, and contact method option 740.

To select a contact with whom to schedule a communications operation, the user may select contact option 710. In response to receiving a user selection of contact option 710, the communications device may provide the user with an opportunity to select a contact using any of the approaches described above in connection with contact option 610 (FIG. 6). In addition, the user may select the communication method to use for the scheduled communications operation using any suitable approach. For example, the user may select contact method option 740 for identifying one or more contact methods. In response to receiving a user selection of contact method option 740, the communications device may provide the user with an opportunity to select a contact method using any of the approaches described above in connection with contact method option 640 (FIG. 6).

The user may select an event at which a communications operation takes place using any suitable approach. In some embodiments, event option 720 may include several events that the user may select. The events may be displayed using any suitable approach. For example, event option 720 may include a listing of events previously scheduled by the user (e.g., events identified from a calendar application). The listing of events may be displayed, for example, in response to receiving a selection of List icon 730. As another example, event option 720 may include a listing of all events scheduled to occur on a particular day (e.g., a display of the events of a single day in a calendar). The events for the single day may be displayed, for example, in response to receiving a selection of Day option 732. As still another example, event option 720 may include calendar display 722 in which events are identified in the box associated with the date at which the event takes place. For example, events may be identified using icons 724 or text in calendar display 722. In response to selecting an icon 724, communications device 702 may be operative to display additional information related to the event associated with the selected icon 724 (e.g., to allow the user to identify or review the event). Calendar display 722 may be displayed, for example, in response to receiving a selection of Month option 734.

In some embodiments, the user may add a new event as a condition for a scheduled communications operation. For example, the user may add a new event to a calendar application available from the communications device. The user may use any suitable approach for adding a new event. For example, the user may select option 736 for accessing a display screen for adding a new event. In response to selecting an option to add a new event, the communications device may display a screen in which the user may enter different information related to the event (e.g., the date and time of the event).

Once the user has finished scheduling a communications operation, the user may select Done option 750 or provide any other suitable input to schedule the requested communications operation. The user may cancel the scheduling of a communications operation by selecting Cancel option 752, or by providing any other suitable input.

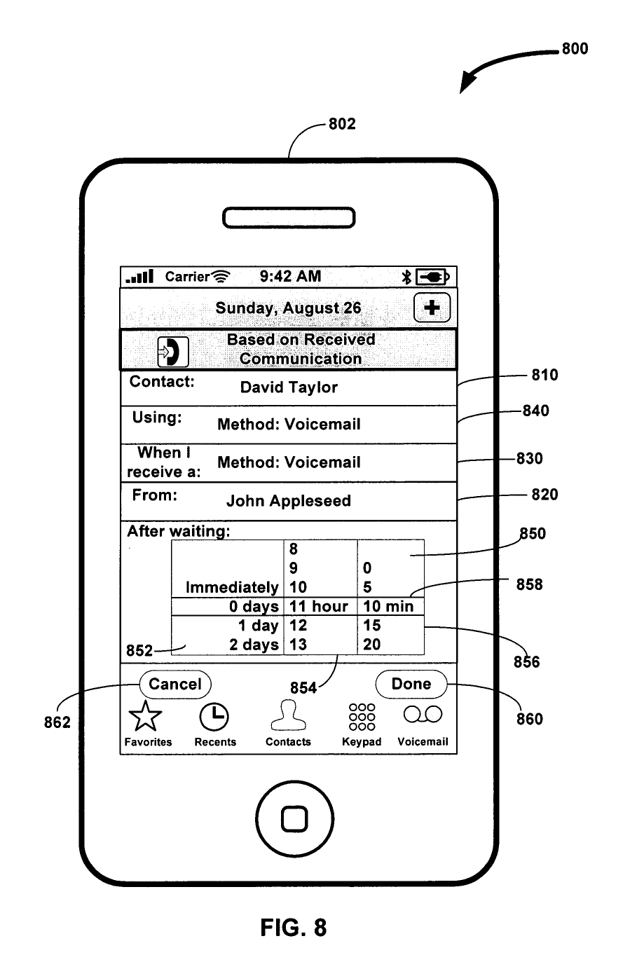

The communications device may display any suitable screen or menu for scheduling a communications operation based on a received communication or the absence of a communication that the user may have expected to receive. FIG. 8 is a schematic view of a display screen for scheduling a communications operation based on a received communication or the absence of an expected communication in accordance with one embodiment of the invention. Display screen 800 may be displayed by communications device 802 in response to receiving a user selection of Received communication option 514 (FIG. 5). Display screen 800 may include several options, including contact option 810, contact method option 840, received contact option 820, and received contact method option 830.

To select a contact with whom to schedule a communications operation, the user may select contact option 810. In response to receiving a user selection of contact option 810, the communications device may provide the user with an opportunity to select a contact using any of the approaches described above in connection with contact option 610 (FIG. 6). In addition, the user may select the communication method to use for the scheduled communications operation using any suitable approach. For example, the user may select contact method option 840 for identifying one or more contact methods. In response to receiving a user selection of contact method option 840, the communications device may provide the user with an opportunity to select a contact method using any of the approaches described above in connection with contact method option 640 (FIG. 6).

The user may define the received communication that serves as the condition for the scheduled communications operation using any suitable approach. In some embodiments, the user may first select the contact from which a communication is received. For example, the user may select received contact option 820. In response to receiving a user selection of received contact option 820, the communications device may provide the user with an opportunity to select a contact using any of the approaches described above in connection with contact option 610 (FIG. 6). In some embodiments, communications device 802 may provide an option for selecting all contacts known to the user, contacts unknown to the user (e.g., contacts not present in the user's address book), or unavailable contacts (e.g., contacts whose contact information is hidden or otherwise not identified).

In addition to selecting the contact from which a communication is received, the user may select the type of communication to be received. For example, the user may select received contact method option 830. In response to receiving a user selection of received contact method option 830, the communications device may provide the user with an opportunity to select a contact method using any of the approaches described above in connection with contact method option 640 (FIG. 6). In some embodiments, the communications device may provide an option for selecting some or all available contact methods.

In some embodiments, the user may define a delay between the time the communication meeting the condition is received and the scheduled communications operation occurs. For example, the user may select a delay option (e.g., delay option 850). The user may define the delay using any suitable approach. For example, delay option 850 may include day wheel 852, hour wheel 854 and minute wheel 856, which the user may independently scroll to select a particular delay after which the scheduled communications operation may occur. The currently selected delay in option 850 (e.g., from each of wheels 852, 854 and 856) may be identified using highlight region 858. In some embodiments, the user may set the delay in delay option 850 to 0 (e.g., set the value of option 850 to “immediately”).

In some embodiments, the user may define the condition for the scheduled communications operation as the absence of an expected communication. For example, a parent may own a communications device 802, and may provide his child with a second communications device 802. The parent may wish to program the child's communication device to perform a communications operation with the parent (e.g., send a text message) when a particular condition is met. As one example, the child's communication device may be set up to transmit a first message when the child arrives at school in the morning and a second text message when the child arrives home again in the afternoon (e.g., messages sent when a location condition is met). As another example, the child's communication device may transmit a message when a communication is received from a banned number (e.g., from another person the parents don't approve of, or from a number unknown to the child) or from an approved number (e.g., a friend calling to schedule a play date). As still another example, the child's communication device may transmit a message in response to determining that the child has sent a communication with a particular contact (e.g., the child has sent a message to a friend while the child should have been studying, such as to a contact before 6 PM). In response to determining that a communications operation scheduled for the child's communications device has not occurred within an allowable time window (e.g., the text message indicating that the child returned home has not been received more than an hour after school ended), the parent's communications device may automatically send a message to the child's communications device.

A user may schedule such a condition using a display screen similar to display screen 800. For example, the display screen may include an option for specifying the contact from whom a communication is expected, and a date/time range during which the communication is expected. In some embodiments, the user may set the condition to repeat (e.g., every weekday). The user may select the type of communication expected using expected contact method option 830. The user (e.g., the parent) may also select the communication method to use for contacting the other user (e.g., the child), if the user's communications device 802 does not receive a communications operation as expected, using any suitable approach. For example, the parent may select contact method option 840 for identifying one or more contact methods (e.g., a phone call).

In some embodiments, in response to determining that the user has selected an option to define an expected received communication (e.g., the user toggles an “expected” option), display screen 800 may include an option for selecting a time period during which the expected communications operation is to be received. For example, display screen 800 may include options similar to options 624, 626 and 628, described above in connection with calendar option 620 (FIG. 6). If the expected communications operation is not received within the set time period, the communications device may be operative to automatically contact the user from whom a communication was expected, or any other suitable user (e.g., a friend, teacher, or public authority).

Once the user has finished scheduling a communications operation, the user may select Done option 860 or provide any other suitable input to schedule the requested communications operation. The user may cancel the scheduling of a communications operation by selecting Cancel option 862, or by providing any other suitable input.

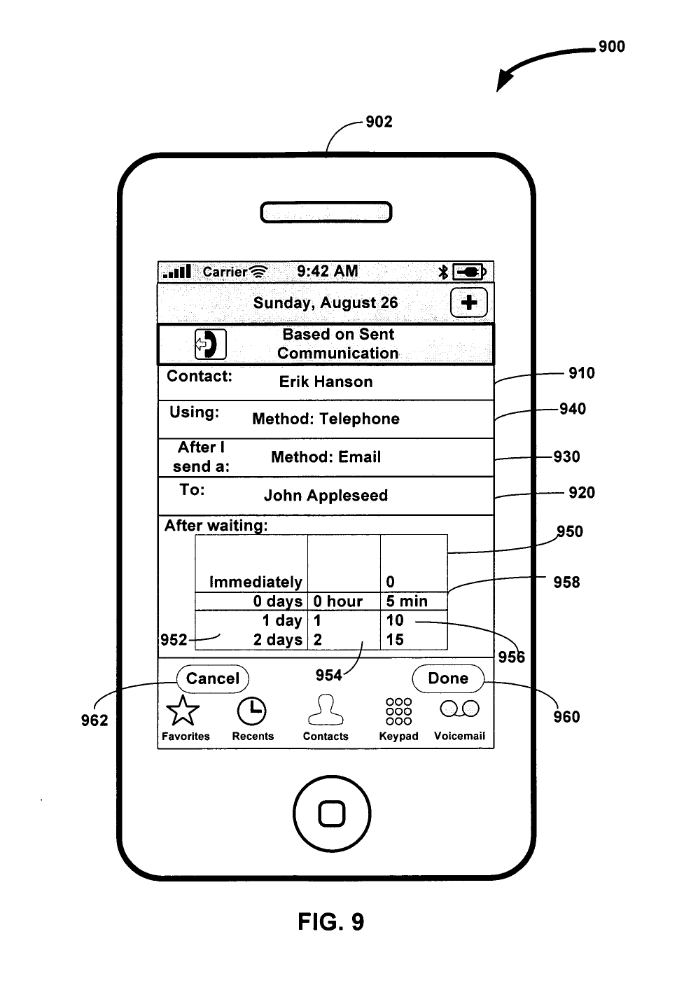

The communications device may display any suitable screen or menu for scheduling a communications operation based on a sent communication. FIG. 9 is a schematic view of a display screen for scheduling a communications operation based on a sent communication in accordance with one embodiment of the invention. Display screen 900 may be displayed by communications device 902 in response to receiving a user selection of Sent communication option 516 (FIG. 5). Display screen 900 may include several options, including contact option 910, contact method 940, sent contact option 920, and sent contact method option 930.

To select a contact with whom to schedule a communications operation, the user may select contact option 910. In response to receiving a user selection of contact option 910, the communications device may provide the user with an opportunity to select a contact using any of the approaches described above in connection with contact option 610 (FIG. 6). In addition, the user may select the communication method to use for the scheduled communications operation using any suitable approach. For example, the user may select contact method option 940 for identifying one or more contact methods. In response to receiving a user selection of contact method option 940, the communications device may provide the user with an opportunity to select a contact method using any of the approaches described above in connection with contact method option 640 (FIG. 6).

The user may define the sent communication that serves as the condition for the scheduled communication using any suitable approach. In some embodiments, the user may first select the contact to which a communication is sent. For example, the user may select sent contact option 920. In response to receiving a user selection of sent contact option 920, the communications device may provide the user with an opportunity to select a contact using any of the approaches described above in connection with contact option 610 (FIG. 6). In some embodiments, communications device 902 may provide an option for selecting some or all contacts known to the user.

In addition to selecting the contact to which a communication is sent, the user may select the type of communication to be sent. For example, the user may select sent contact method option 930. In response to receiving a user selection of sent contact method option 930, the communications device may provide the user with an opportunity to select a contact method using any of the approaches described above in connection with contact method option 640 (FIG. 6). In some embodiments, the communications device may provide an option for selecting some or all available contact methods.

In some embodiments, the user may define a delay between the time the communication meeting the condition is sent and the scheduled communications operation occurs. For example, the user may select a delay option (e.g., delay option 950). The user may define the delay using any suitable approach. For example, delay option 950 may include day wheel 952, hour wheel 954 and minute wheel 956, which the user may independently scroll to select a particular delay after which the scheduled communications operation may occur. The currently selected delay in option 950 (e.g., from each of wheels 952, 954 and 956) may be identified using highlight region 958. In some embodiments, the user may set the delay in delay option 950 to 0 (e.g., set the value of option 950 to “immediately”).

Once the user has finished scheduling a communications operation, the user may select Done option 960 or provide any other suitable input to schedule the requested communications operation. The user may cancel the scheduling of a communications operation by selecting Cancel option 962, or by providing any other suitable input.

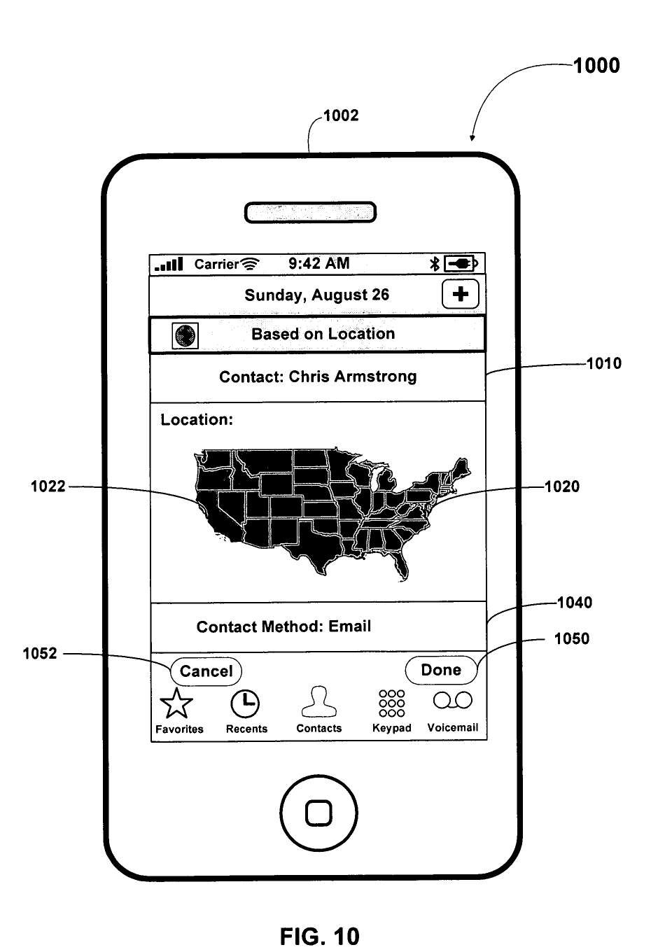

The communications device may display any suitable screen or menu for scheduling a communications operation based on a location. FIG. 10 is a schematic view of a display screen for scheduling a communications operation based on a location in accordance with one embodiment of the invention. Display screen 1000 may be displayed by communications device 1002 in response to receiving a user selection of Location option 518 (FIG. 5). Display screen 1000 may include several options, including contact option 1010, location option 1020, and contact method option 1040.

To select a contact with whom to schedule a communications operation, the user may select contact option 1010. In response to receiving a user selection of contact option 1010, the communications device may provide the user with an opportunity to select a contact using any of the approaches described above in connection with contact option 610 (FIG. 6). In addition, the user may select the communication method to use for the scheduled communications operation using any suitable approach. For example, the user may select contact method option 1040 for identifying one or more contact methods. In response to receiving a user selection of contact method option 1040, the communications device may provide the user with an opportunity to select a contact method using any of the approaches described above in connection with contact method option 640 (FIG. 6).

The user may select a location to serve as a condition for a scheduled communications operation (e.g., the scheduled communications operation occurs when the communications device is at the selected location) using any suitable approach. Location option 1020 may include any suitable field or interface for selecting a location. For example, location option 1020 may include a field for entering coordinates or an address for a location (e.g., GPS coordinates or a mailing address). As another example, location option 1020 may include a search field that the user may use to find a particular location (e.g., search for Starbucks coffee shops in a particular city). As still another example, location option 1020 may include a map that the user may manipulate to select a particular location on the map.

In the example of FIG. 10, location option 1020 may include a map of the United States of America, and highlight region 1022 may be operative to identify the currently selected region of the map. In response to receiving a selection of a particular region, the communications device may provide an option for zooming in to refine the user's selected region (e.g., to move from selecting a state to selecting a county or city). The user may successively refine the selected region until the desired region has been selected. In some embodiments, the user may select a type of location (e.g., movie theaters) within a geographic region as the selected location. For example, the user may select all movie theaters in a particular zip code (e.g., using Google Maps and the search feature). Then, when the user enters a movie theater, the communications device may automatically send a text message to a friend to invite the friend to the movie theater.

Once the user has finished scheduling a communications operation, the user may select Done option 1050 or provide any other suitable input to schedule the requested communications operation. The user may cancel the scheduling of a communications operation by selecting Cancel option 1052, or by providing any other suitable input.

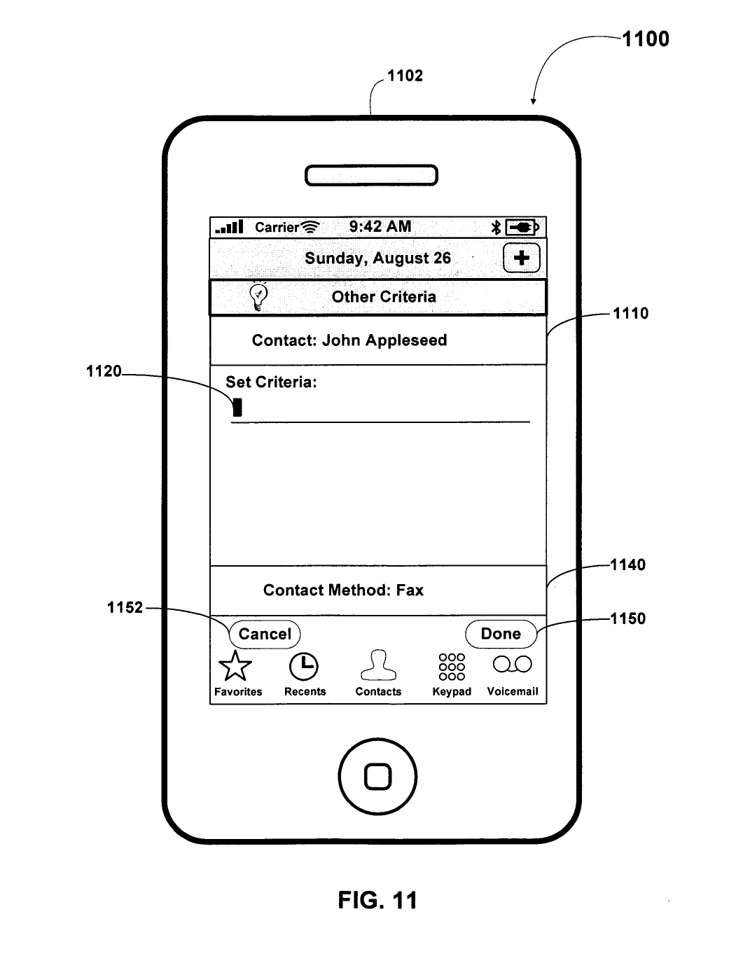

The communications device may display any suitable screen or menu for scheduling a communications operation based on any other suitable criteria. FIG. 11 is a schematic view of a display screen for scheduling a communications operation based on a suitable criteria in accordance with one embodiment of the invention. Display screen 1100 may be displayed by communications device 1102 in response to receiving a user selection of Other criteria option 520 (FIG. 5). Display screen 1100 may include several options, including contact option 1110, other criteria option 1120, and contact method option 1140.

To select a contact with whom to schedule a communications operation, the user may select contact option 1110. In response to receiving a user selection of contact option 1110, the communications device may provide the user with an opportunity to select a contact using any of the approaches described above in connection with contact option 610 (FIG. 6). In addition, the user may select the communication method to use for the scheduled communications operation using any suitable approach. For example, the user may select contact method option 1140 for identifying one or more contact methods. In response to receiving a user selection of contact method option 1140, the communications device may provide the user with an opportunity to select a contact method using any of the approaches described above in connection with contact method option 640 (FIG. 6).

The user may provide any other suitable criteria to serve as a condition for a scheduled communications operation (e.g., the scheduled communications operation occurs when the provided criteria is met) using any suitable approach. Other criteria option 1120 may include any suitable field or interface for defining criteria serving as a condition for a scheduled communications operation (e.g., a keypad or keyboard may appear in response to receiving a selection of field for entering text). The user may provide any suitable criteria using any suitable syntax or language. For example, the user may provide criteria using specific language that may be parsed by the communications device (e.g., limited strings with Boolean operators). As another example, the user may provide criteria using natural language. In some embodiments, the criteria provided in other criteria option 1120 may include combinations of other types of conditions, or different conditions.

Once the user has finished scheduling a communications operation, the user may select Done option 1150 or provide any other suitable input to schedule the requested communications operation. The user may cancel the scheduling of a communications operation by selecting Cancel option 1152, or by providing any other suitable input.

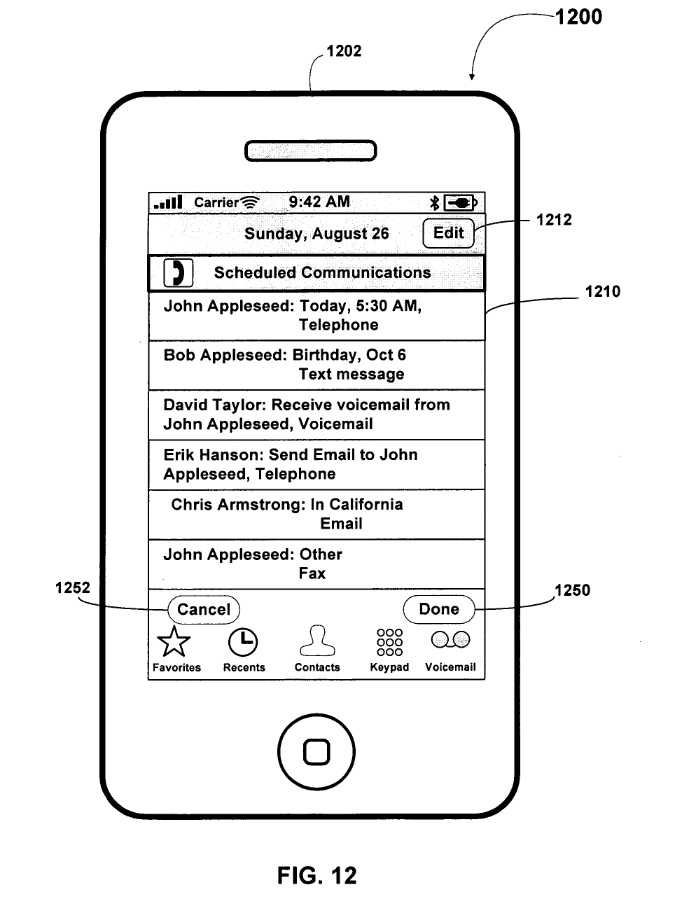

The user may review scheduled communications using any suitable approach. For example, the user may select a scheduled communications operations option from display screen 500 (FIG. 5, not shown). As another example, the user may provide a scheduled communications operations input using the input mechanism. In response to receiving such a selection, the communications device may display a listing of scheduled communications operations. FIG. 12 is a schematic view of a display screen for viewing scheduled communications operations in accordance with one embodiment of the invention. Display screen 1200 may be displayed by display device 1202 in response to any suitable request to view communications operations scheduled by the user or by the device. Display screen 1200 may include listings 1210 of communications operations scheduled by the user or by users of the device. Each listing 1210 may include any suitable information, including for example sufficient information for identifying each scheduled communications operation. Such information may include, for example, the contact, the contact method, the condition and/or condition value for the communications operation, or any other suitable information. The user may select a listing 1210 to view more information for the particular scheduled communications operation. In response to selecting a listing, the communications device may display a screen for setting up the communications operation (e.g., one of the display screens of FIGS. 6-11). The user may then modify a scheduled communications operation, and return to display screen 1200 (e.g., by selecting a Done option 1250).

In some embodiments, the user may delete a scheduled communications operation from display screen 1200. For example, the user may select Edit option 1212, in response to which a selection of a listing 1210 will cause a prompt to delete the listing (and underlying communications operation) to appear. The user may select the prompt to delete a listing.

Once the user has finished reviewing scheduled communications operations, the user may select Done option 1250 or provide any other suitable input to apply changes to the scheduled communications operations. The user may cancel changes to the scheduled communications operations by selecting Cancel option 1252, or by providing any other suitable input.

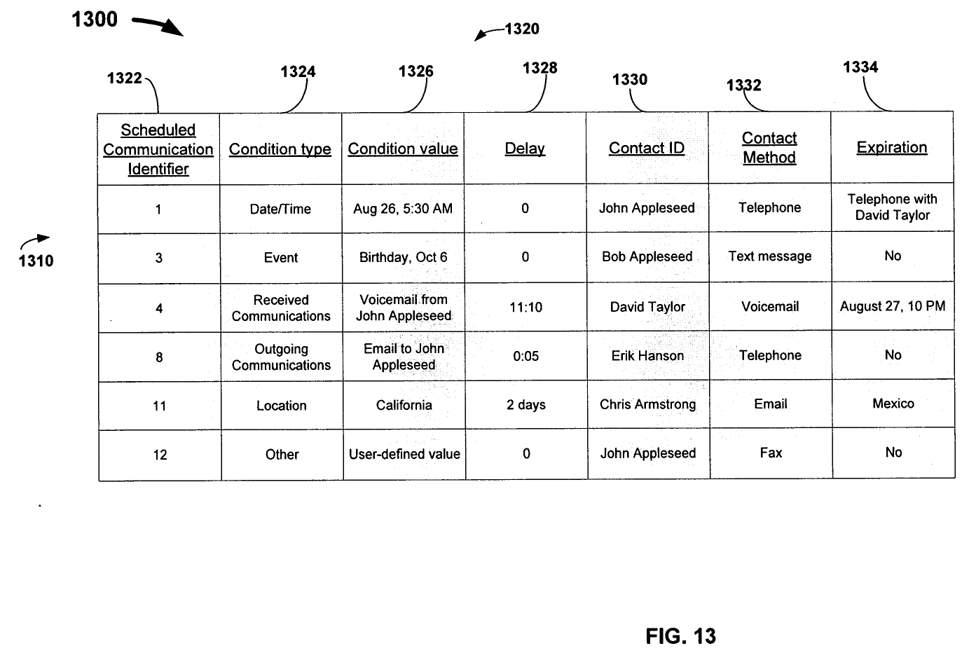

The communications device may store scheduled communications operations in memory using any suitable data structure. FIG. 13 is a schematic view of an illustrative data structure for storing scheduled communications operations in accordance with one embodiment of the invention. Data structure 1300 may include rows 1310 of scheduled communications operations, and columns 1320 of scheduled communications operations settings. Each scheduled communications operation may be uniquely identified by a scheduled communication identifier (e.g., a number or character string) stored in column 1322. In some embodiments, data structure 1300 may limit the maximum number of scheduled communications operations that the user may schedule. For example, data structure 1300 may limit the number of rows 1310 available.

The condition type and condition value for each scheduled communications operation may be stored in columns 1324 and 1326, respectively. The condition type may include any of the condition types shown in the options of display screen 500 (FIG. 5). The condition value may include a date/time, event ID, communications operation, location, or any other data defining a value to which the communications device can compare (e.g., compare current date/time to condition date/time) to determine whether the condition is met. Using the condition values stored in column 1326, the communications device may prevent the scheduling of conflicting communications operations (e.g., two communications operations scheduled at the same time) and bring the conflict to the user's attention. In some embodiments, the communications device may instead perform both communications operations sequentially (e.g., starting with the first one scheduled, or with the one whose contact has a higher priority, for example the user's boss). Column 1328 may include the delay after the condition is met for performing the communications operation. The data stored in column 1328 may be any suitable measure of time (e.g., a measure of minutes/hours, or a date and time).

The person to contact and the method for contacting the selected person may be stored in columns 1330 and 1332, respectively. In some embodiments, the contact information stored in column 1330 may include a reference to the user's address book or contact list (e.g., the contact ID). Alternatively, the contact information may include a number or address to which a communications operation should be directed. The contact method stored in column 1332 may include any suitable contact method, including for example telephone, text message, voicemail, email, or fax.

The communications device may store expiration information for each scheduled communications operation in column 1334. The data stored in column 1334 may include a Boolean (e.g., yes/no). In some embodiments, instead of the Boolean indicating that a scheduled communications operation may expire, column 1334 may include a value for when the scheduled communications operation expires. The value may take any suitable form, including for example a measure of time (e.g., a date/time), a location, a prior communications operation (e.g., alone or in addition to a time constraint), combinations thereof, or any other suitable form.

When the user creates a new scheduled communications operation (e.g., selects a Done option after setting the parameters for the communications operation), the communications device may add a new row to data structure 1300. When the user removes a scheduled communications operation, the communications device may delete or remove the row of data structure 1300 associated with the deleted scheduled communications operation. When a scheduled communications operation occurs, the communications device may keep the row in data structure 1300 that is associated with the communications operation (e.g., but set a flag or change a setting to indicate that the communications operation has occurred), or may delete the row associated with the scheduled communications operation. If a scheduled communications operation is attempted unsuccessfully, the communications device may keep the row associated with the communications operation in data structure 1300, and re-attempt the communications operation.

In some embodiments, data structure 1300 may include a column for the message to be sent with each scheduled communications operation (if applicable). For example, data structure 1300 may include a messages column (not shown). The data stored in the messages column may include pointers to messages stored in memory (e.g., archived messages, or default messages).

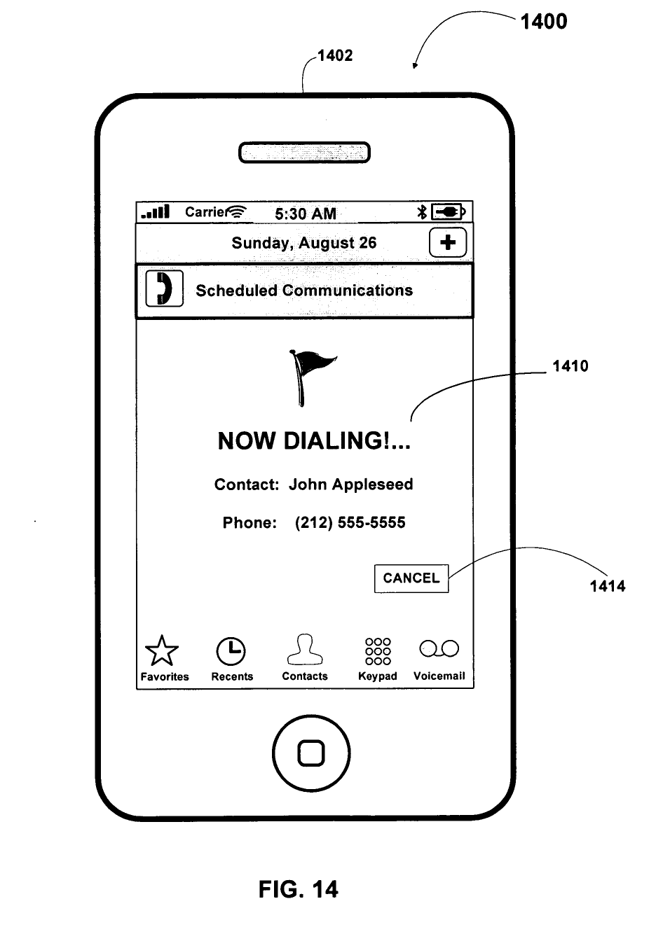

When a condition is met, the communications device may initiate a scheduled communications operation. The communications operation may display any suitable screen to indicate to the user that the scheduled communications operation is occurring. FIG. 14 is a schematic display screen of a scheduled communications operation as it is initiated in accordance with one embodiment of the invention. Display screen 1400 may be displayed by communications device 1402 when a condition for conducting a scheduled communications operation is met. Display screen 1400 may include contact information 1410 identifying the person being contacted to the user. The user may cancel the scheduled communications operation by selecting Cancel option 1414. Display screen 1400 may include any other suitable information, including for example the condition that was met for the scheduled communications operation to occur (e.g., display the condition type and condition value of columns 1324 and 1326 of data structure 1300, FIG. 13).

Communications device 1402 may indicate to the user that a scheduled communications operation is occurring using any suitable approach. For example, instead of or in addition to displaying the information of display screen 1400, communications device 1402 may provide an audio or vibrational indication that a scheduled communications operation is occurring or is soon to occur. For example, communications operation 1402 may display a screen, vibrate, or ring before the scheduled communications operation is to occur to allow the user to prepare themselves for the communications operation (e.g., excuse themselves from a conversation to be available for the communications operation). If the user is not available at the time the scheduled communications operation is to occur, the user may select an option to cancel or delay (e.g., press a “sleep” option) the scheduled communications operation.

In some embodiments, communications device 1402 may provide an additional indication (e.g., audio or vibration in addition to the display) only once a communications operation has been established (e.g., once the contact has answered the telephone call). If the user does not participate in the communications operation (e.g., does not start talking during a telephone call), communications device 1402 may provide a generic or default message to the contact indicating that the user had a communications operation scheduled, but is not available now and will try again later. Communications device 1402 may then automatically re-schedule the communications operation for a later time. Communications device 1402 may instead or in addition provide an indication to the user of the missed scheduled communications operation (e.g., in the same manner voicemails are indicated).

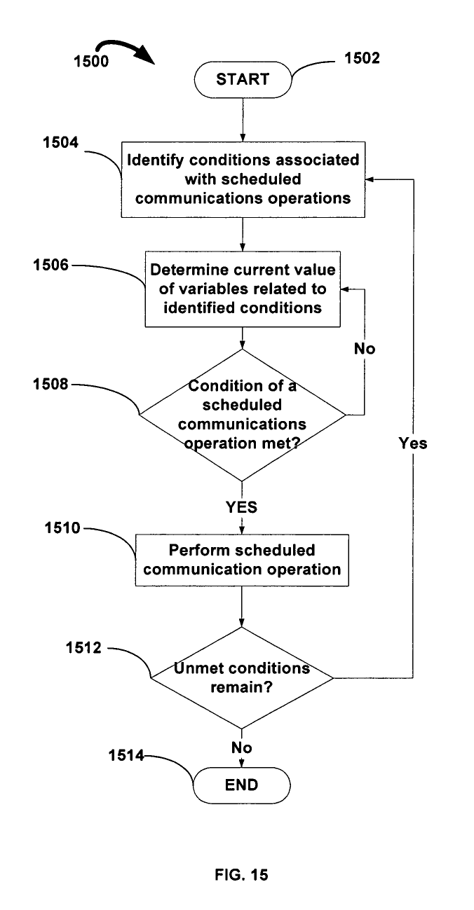

FIG. 15 is a flow chart of an illustrative process for performing a scheduled communications operation in accordance with one embodiment of the invention. Process 1500 may begin at step 1502. At step 1504, the communications device may identify conditions associated with scheduled communications operations. For example, the communications device may access data structure 1300 (FIG. 13) and read the condition types and condition values stored in columns 1324 and 1326, respectively (FIG. 13). At step 1506, the communications device may determine the current value of the variables related to the conditions identified at step 1504. For example, the communications device may determine the current date and time, the current location of the communications device, whether events from the user's calendar are occurring, past or current communications operations performed by the communications device, or any other suitable information related to the values of variables related to the conditions of the scheduled communications operations.

At step 1508, the communications device may determine whether a condition of a scheduled communications operation has been met. For example, the communications device may compare the values identified at step 1506 with the condition values retrieved from memory at step 1504. If the communications device determines that the current values (e.g., identified at step 1506) do not meet the condition values (e.g., identified at step 1504), process 1500 may return to step 1506 and re-sample the current values of data related to the condition values.

If, at step 1508, the communications device instead determines that the current values meet the condition values, process 1500 may move to step 1510. At step 1510, the communications device may perform the scheduled communications operation for which the condition was met. At step 1512, the communications device may determine whether there are remaining scheduled communications operations with unmet conditions. If the communications device determines that there are remaining scheduled communications operations with unmet conditions, process 1500 may return to step 1504 and identify the condition values for the remaining scheduled communications operations. If, at step 1512, the communications device instead determines that there are no remaining scheduled communications operations with unmet conditions, process 1500 may move to step 1514 and end.

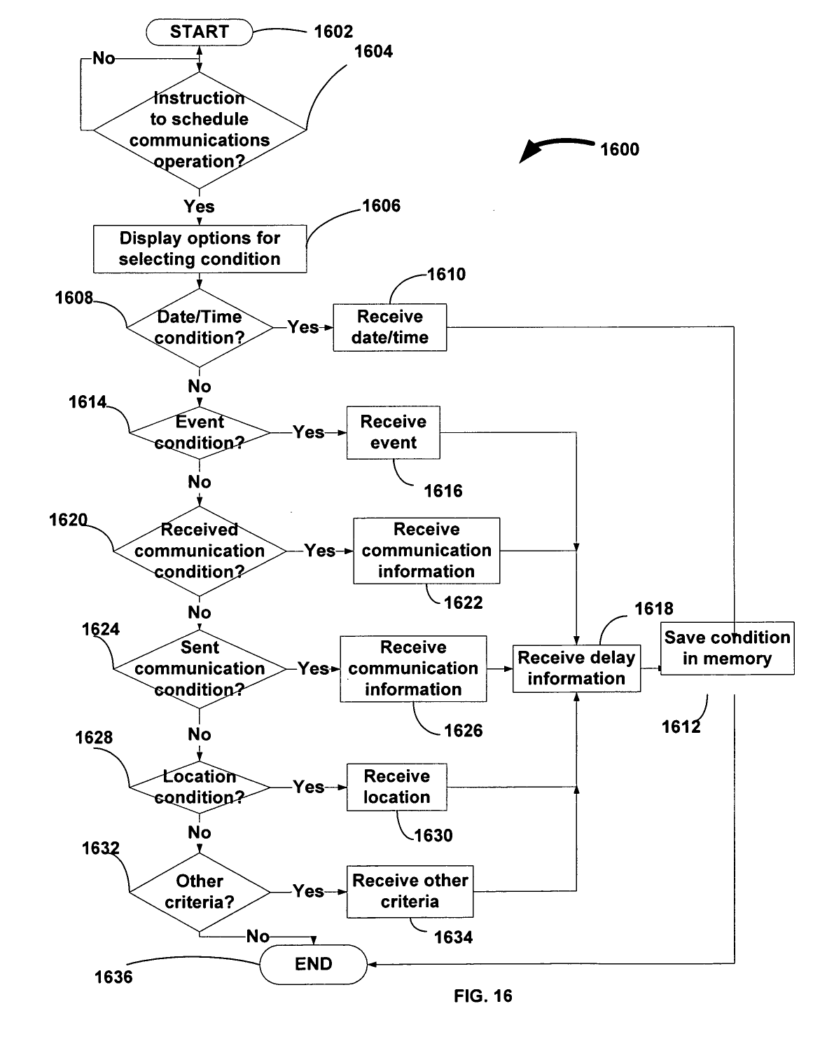

FIG. 16 is a flowchart of an illustrative process for scheduling a communications operation in accordance with one embodiment of the invention. Process 1600 may begin at step 1602. At step 1604, the communications device may receive an instruction to schedule a communications operation. For example, the communications device may receive a user instruction to access display screen 500 (FIG. 5). At step 1606, the communications device may display options for selecting a condition for a scheduled communications operation. For example, the communications device may display a series of selectable options, each defining a different condition for a scheduled communications operation. At step 1608, the communications device may receive a user selection of a displayed option. For example, the communications device may receive a user selection of an option displayed at step 1606.

At step 1610, the communications device may determine whether the selected option is an option for scheduling a communications operation based on date and time. If the communications device determines that the selected option is an option for scheduling a communications operation based on date and time, process 1600 may move to step 1612. At step 1612, the communications device may receive a date and a time at which to perform the scheduled communications operation. At step 1614, the communications device may receive a selection of a contact with which to perform a communications operation at the selected date and time. At step 1616, the communications device may receive a selection of a contact method by which to communicate with the selected contact. The communications device may save the received information in memory (e.g., in data structure 1300, FIG. 13). Process 1600 may then end at step 1640.

If, at step 1610, the communications device instead determines that the selected option is not an option for scheduling a communications operation based on date and time, process 1600 may move to step 1618. At step 1618, the communications device may determine whether the selected option is an option to schedule a communications operation based on an event. If the communications device determines that the selected option is an option to schedule a communications operation based on an event, process 1600 may move to step 1620. At step 1620, the communications device may receive a selection of an event, the occurrence of which may cause the communications device to perform the scheduled communications operation. At step 1622, the communications device may receive delay information, if applicable. For example, the communications device may receive information regarding how long to delay the scheduled communications operation once the condition is met. Process 1600 may then move to step 1614, described above.

If, at step 1618, the communications device instead determines that the selected option is not an option to schedule a communications operation based on an event, process 1600 may move to step 1624. At step 1624, the communications device may determine whether the selected option is an option to schedule a communications operation based on a received communication. If the communications device determines that the selected option is an option to schedule a communications operation based on a received communication, process 1600 may move to step 1626. At step 1626, the communications device may receive information defining the received communication that serves as the condition for the scheduled communications operation. Process 1600 may then move to step 1622, described above.

If, at step 1624, the communications device instead determines that the selected option is not an option to schedule a communications operation based on a received communication, process 1600 may move to step 1628. At step 1628, the communications device may determine whether the selected option is an option to schedule a communications operation based on a sent communication. If the communications device determines that the selected option is an option to schedule a communications operation based on a sent communication, process 1600 may move to step 1630. At step 1630, the communications device may receive information defining the sent communication that serves as the condition for the scheduled communications operation. Process 1600 may then move to step 1622, described above.

If, at step 1628, the communications device instead determines that the selected option is not an option to schedule a communications operation based on a sent communication, process 1600 may move to step 1632. At step 1632, the communications device may determine whether the selected option is an option to schedule a communications operation based on a location. If the communications device determines that the selected option is an option to schedule a communications operation based on a location, process 1600 may move to step 1634. At step 1634, the communications device may receive the location from which the communications device will perform the scheduled communications operation. Process 1600 may then move to step 1622, described above.

If, at step 1632, the communications device instead determines that the selected option is not an option to schedule a communications operation based on a location, process 1600 may move to step 1636. At step 1636, the communications device may determine whether the selected option is an option to schedule a communications operation based on other criteria. If the communications device determines that the selected option is an option to schedule a communications operation based on other criteria, process 1600 may move to step 1638. At step 1638, the communications device may receive the other criteria that serves as the condition for the scheduled communications operation. Process 1600 may then move to step 1622, described above.

If, at step 1636, the communications device instead determines that the selected option is not an option to schedule a communications operation based on other criteria, process 1600 may move to step 1640 and end.

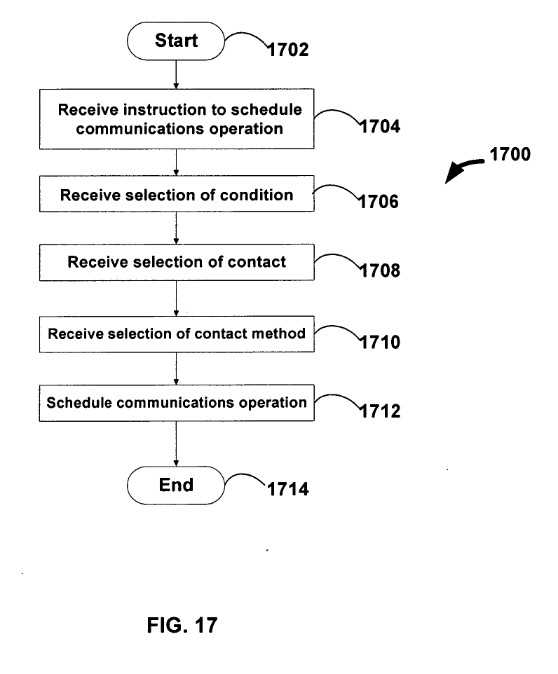

FIG. 17 is a flowchart of an illustrative process for scheduling a communications operation in accordance with one embodiment of the invention. Process 1700 may begin at step 1702. At step 1704, the communications device may receive a user instruction to schedule a communications operation. In response to receiving the user instruction, the communications device may display any suitable menu or option for scheduling a communications operation. For example, the communications device may display a listings of selectable conditions for scheduling a communications operation (e.g., display screen 500, FIG. 5).

At step 1706, the communications device may receive a selection of a condition. For example, the communications device may receive a user selection of a displayed condition type. In response to receiving the user selection of the condition type, the communications device may display a selectable option for defining a condition value associated with the condition type. The user may select a value to complete the definition of the condition for the scheduled communications operation.

At step 1708, the communications device may receive a user selection of one or more contacts with whom to perform the scheduled communications operation. For example, the communications device may receive a user selection of one or more contacts from an address book, or may receive one or more contacts entered using a keypad or keyboard. At step 1710, the communications device may receive a user selection of a contact method. Suitable contact methods may include, for example, telephone, voicemail, email, text messaging, chatting, fax, or any other suitable contact method.

In some embodiments, the communications device may receive any other option or setting related to the scheduled communications operation. For example, the communications device may receive an instruction to delay a scheduled communications operation once the condition is met, to select a particular message to transmit as part of the communications operation, to have a scheduled communications operation expire, or any other suitable option or setting. At step 1712, the communications device may schedule the communications operation. For example, the communications device may store the settings associated with the communications operation in memory (e.g., in data structure 1300, FIG. 13). Process 1700 may then end at step 1714.

One skilled in the art will appreciate that the invention can be practiced by other than the prescribed embodiments, which are presented for purposes of illustration and not of limitation, and the invention is limited only by the claims which follow.

What is claimed is:

1. A method for scheduling a communications operation to be performed by a communications device, the method comprising:
receiving a condition for performing the scheduled communications operation;
determining whether the condition is satisfied; and
performing the scheduled communications operation in response to determining that the received condition is satisfied.

2. The method of claim 1, further comprising receiving a contact with whom to perform the communications operation.

3. The method of claim 1, further comprising receiving a type of communications operation to perform.

4. The method of claim 3, wherein the communications operation is at least one of telephone, email, voicemail, text message, chat, and fax.

5. The method of claim 1, wherein the condition is at least one of a date, a time, an event, a location, a received communications operation, the absence of an expected communications operation, and a sent communications operation.

6. The method of claim 1, wherein the scheduled communications operation is not performed immediately in response to receiving the condition.

7. A system for performing a scheduled communications operation, the system comprising:
a first communications device for initiating a scheduled communications operation; and
a second communications device for receiving the scheduled communications operation;
wherein the first communications device initiates the scheduled communications operation in response to determining that a condition associated with the scheduled communications operation is satisfied.

8. The system of claim 7, wherein the first communications device receives the condition, contact information for the second communications device, and a contact method for performing the scheduled communications operation.

9. A communications device for scheduling a communications operation, the communications device comprising control circuitry and communications circuitry, the control circuitry operative to:
receive a user selection of a condition;
receive a user selection of a contact;
receive a user selection of a contact method; and
schedule a communications operation with the received contact using the received contact method, wherein the control circuitry is operative to direct the communications circuitry to perform the scheduled communications operation in response to determining that the received condition is satisfied.

10. The communications device of claim 9, wherein the condition is at least one of a date, a time, an event, a location, a received communications operation, the absence of an expected communications operation, and a sent communications operation.

11. The communications device of claim 9, wherein the contact method is at least one of telephone, email, voicemail, text message, chat, and fax.

12. The communications device of claim 9, wherein the control circuitry is further operative to:
receive a user selection of a delay; and
wait for the delay to lapse after determining that the received condition is satisfied before directing the communications circuitry to perform the scheduled communications operation.

13. The communications device of claim 9, wherein the control circuitry is operative to:
receive an expiration condition; and
cancel the scheduled communications operation if the expiration condition is satisfied before the received condition for performing the scheduled communications operation.

14. The communications device of claim 9, wherein the control circuitry is operative to display a listing of scheduled communications operations to the user.

15. The communications device of claim 9, wherein the control circuitry is operative to save the settings for scheduled communications operations in memory.

16. A communications device for performing a scheduled communications operation, the communications device comprising control circuitry, memory and communications circuitry, the control circuitry operative to:
identify at least one scheduled communications operation stored in memory;
identify a condition associated with each of the identified at least one scheduled communications operations;
determine that one of the identified conditions is satisfied; and
in response to determining that one of the identified conditions is satisfied, direct the communications circuitry to perform the scheduled communications operation associated with the identified condition that is satisfied.

17. The communications device of claim 16, wherein the control circuitry is further operative to indicate in memory that the performed scheduled communications operation is performed.

18. The communications device of claim 16, wherein the control circuitry is operative to:
determine whether two of the at least one scheduled communications operations conflict; and
resolve the conflict by determining which of the two communications operations has a higher priority.

19. The communications device of claim 16, wherein the condition is at least one of a date, a time, an event, a location, a received communications operation, the absence of an expected communications operation, and a sent communications operation.

20. The communications device of claim 16, wherein the communications operation is at least one of telephone, email, voicemail, text message, chat, and fax.

21. The communications device of claim 16, wherein the control circuitry is operative to:
determine whether the user of the communications device is available to participate in the scheduled communications operation; and
in response to determining that the user of the communications device is not available, direct the communications circuitry to transmit a generic message.

22. A method for performing a scheduled communications operation using a communications device, comprising:
identifying scheduled communications operations;
identifying conditions associated with the identified scheduled communications operations;
determining whether at least one of the identified conditions is satisfied; and
in response to determining that at least one of the identified conditions is satisfied, performing the scheduled communications operation associated with the satisfied identified condition.

23. The method of claim 22, wherein performing the scheduled communications operation further comprises alerting a user that the scheduled communications operation is being performed.

24. The method of claim 23, wherein performing the scheduled communications operation further comprises:
determining whether the user is available to participate in the scheduled communications operation; and
in response to determining that the user is not available to participate in the scheduled communications operation, transmitting a default message.

25. The method of claim 24, further comprising receiving a user selection of the default message.
